(19) United States
(12) Patent Application Publication
(10) Pub. No.: US 2018/0152060 A1
(43) Pub. Date: May 31, 2018

(54) DOUBLE U-CORE SWITCHED RELUCTANCE MACHINE

(71) Applicant: AALBORG UNIVERSITET, Aalborg Ø (DK)

(72) Inventors: Peter RASMUSSEN, Nørresundby (DK); Kristian KONGERSLEV, Aalborg (DK); Rasmus JAEGER, Aalborg (DK); Simon Staal NIELSEN, Aalborg (DK)

(73) Assignee: AALBORG UNIVERSITET, Aalborg Ø (DK)

(21) Appl. No.: 15/577,427

(22) PCT Filed: Jun. 10, 2016
(86) PCT No.: PCT/DK2016/050178

§ 371 Date: Nov. 28, 2017

(30) Foreign Application Priority Data
Jun. 12, 2015 (DK) PA2015 00335

(51) Int. Cl. H02K 1/14; H02K 1/24; H02K 3/18; H02K 7/116; H02K 1/18; H02K 1/20; H02K 19/10

(52) U.S. Cl. CPC H02K 1/148; H02K 1/246; H02K 3/18; H02K 7/083; H02K 1/185; H02K 1/20; H02K 19/103; H02K 7/116

(57) ABSTRACT

The present invention relates to an electrical machine stator comprising a plurality of stator segments (131,132,133), each segment comprises a first U-core and a second U-core wound with a winding, where the winding being arranged with at least one coil turn, each coil turn comprises a first axial coil segment and a second axial coil segment and one or more end segments, wherein the first and second axial coil segments are arranged in opposite directions to each other, and where the first U-core receives the first axial coil segment(s) and the second U-core receives the second axial coil segment(s), wherein the first U-core and the second U-core are located adjacent to each other, whereby the winding spans the first and second U-cores. The invention also relates to a SRM machine with a stator mentioned above and a rotor.

### FIELD OF THE INVENTION

The present invention relates to a switched reluctance machine (SRM).

### BACKGROUND

The background of the invention is the U-core technology presented in U.S. Pat. No. 7,312,549. U.S. Pat. No. 7,312,549 solves many of the known problems of conventional SRM. The flux path of the machine is much shorter, the magnetic mutual coupling between the phases is lower. However the prior art has the disadvantage that large amount of end windings is obtained.

It was found that the longer end windings resulted in excessive copper losses, mutual coupling, as well as increased 3D effects. Furthermore, it was found that excessive eddy current losses are present in the wedges containing the cooling channels, as well as the stator housing, surrounding the U-cores.

US 20120306297 shows a machine which proposes the use of PI-cores, which are wound around the legs of the stator cores. However, the solution suffers from the fact, that the copper present on the outside of the legs do not add to the mmf produced, hence this can effectively be seen as end winding.

US 2014/0021809 discloses reluctance motors herein comprise a rotor having a plurality of radially outwardly projecting rotor poles and a plurality of generally U-shaped stator units positioned circumferentially around the rotor. Each stator unit is spaced circumferentially apart and magnetically isolated from adjacent stator units. Each stator unit comprises a circumferentially extending yoke and two stator poles extending radially inwardly from the yoke, such that the stator poles are positioned adjacent to the rotor poles. The motor further comprises a plurality of coils of electrical conductors, wherein each of the coils is coiled around a respective one of the yokes of the stator units. In some embodiments, non-magnetic stator supports are positioned between the stator units and configured to engage circumferential sides of the stator units to hold the stator units in radial and circumferential alignment with the rotor.

It is an object to present a machine which utilizes shorter end windings and provide better cooling properties, while maintaining the said advantages.

### SUMMARY OF THE INVENTION

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Thus, the above described object and several other objects are intended to be obtained in a first aspect of the invention, where an electrical machine stator comprises a plurality of stator segments, each segment comprises a first U-core and a second U-core wound with a winding,
said winding being arranged with at least one coil turn, each coil turn comprises a first axial coil segment and a second axial coil segment and one or more end segments, wherein the first and second axial coil segments are arranged in opposite directions to each other,
the first U-core receives the first axial coil segment(s) and the second U-core receives the second axial coil segment(s), wherein the first U-core and the second U-core are located adjacent to each other, whereby the winding spans the first and second U-cores.

The advantages of the first aspect, of the double U-core are that the amount of end winding is reduced and that the end windings of each phase are physically completely independent on each other, resulting in compact end windings which are easier to cool and which exhibits minimal mutual coupling. The result is a compact stator segment which may be pre-wound before assembly of the stator. Further more, the number of stator segments is halved when utilising double U-cores compared to using four separate U-cores.

According to one embodiment the plurality of stator segments are arranged in a circular manner, adjacent to each other with a separation block between the adjacent segments, wherein the separation blocks being of an electrically and magnetically non-conducting material.

According to one embodiment the winding of each of the plurality of stator segments alternates in a sequence of a plurality of electrical phases, such as three electrical phases.

According to one embodiment the stator segment comprises a separation gap between the first U-core and the second U-core.

According to one embodiment the separation gap comprises at least one bridge connecting the first U-core and the second U-core.

According to one embodiment the bridge comprises at least one hole in axial direction, said hole can be used for axial clamping and/or as a cooling channel.

According to one embodiment the stator comprises a circular ring around the plurality of stator segments, said circular ring provides a firm structural support to the plurality of stator segments.

According to one embodiment the circular ring is crimped around the plurality of stator segments as a pre-stressed outer compression ring.

Advantage of the embodiment is a reduced acoustic noise and improved thermal capabilities.

According to one embodiment a plurality of spacer fillings, where the empty spaces may be filled with preferable non-magnetic and/or non-conducting filling material.

Advantage of this embodiment is to improve the structural stiffness of the machine.

According to one embodiment of the invention the filling material is a ceramic based material, polymer material or cement based material.

An advantage of the embodiment is that the density of the filling material provides a dampening effect on the structure of the double U-core SRM.

In a second aspect of an electrical machine comprises a rotor and a stator, wherein the stator is according to the first aspect and its embodiments.

According to one embodiment of the invention a gear is included inside the rotor.

Many of the attendant features will be more readily appreciated as the same become better understood by reference to the following detailed description considered in connection with the accompanying drawings. The preferred features may be combined as appropriate, as would be apparent to a skilled person, and may be combined with any of the aspects of the invention.

### BRIEF DESCRIPTION OF THE DRAWINGS

FIG. 1 shows a U-core SRM from U.S. Pat. No. 7,312,549;

FIG. 2 shows a section of a double U-core SRM, with short end windings;

FIG. 3 shows an embodiment of a double U-core SRM with cooling channels.

FIG. 4 shows the phases of a three phase machine;

FIG. 5 shows prior art embodiment where the coil runs around the U-core yoke;

FIG. 6 shows stator core and coil configuration of the prior art U-core SRM;

FIG. 7 shows stator core and coil configuration of a section of an embodiment of the double U-core SRM;

FIG. 8 shows two neighbouring U-core resembling an E-core when placed next to each other;

FIG. 9 shows double U-core with bridge between the U-cores;

FIG. 10 shows an embodiment of a 24/20 configuration of the U-core topology;

FIG. 11 shows spacers between the stator poles which improves the mechanical stiffness of the stator.

FIG. 12 shows example of implementation of planetary gear inside a rotor.

FIG. 13 shows an example of a double U-core SRM used for initial analysis.

FIG. 14 shows flux lines for the prior art U-core SRM (left side) and double U-core SRM (right side), with 25 flux lines and 50 flux lines respectively.

FIG. 15 shows flux density at 15 A/mm2 for the two machines of FIG. 14.

FIG. 16 shows magnetisation curves for the prior art U-core SRM (v1) and the double U-core SRM (v2).

FIG. 17 shows Torque (left) of the prior art U-core SRM (v1) and double U-core SRM (v2) at different current densities (100% fill factor) as well as the factor between the two (right).

### DETAILED DESCRIPTION OF THE INVENTION

The present invention will now be explained in further details. While the invention is susceptible to various modifications and alternative forms, specific embodiments have been disclosed by way of examples. It should be understood, however, that the invention is not intended to be limited to the particular forms disclosed. Rather, the invention is to cover all modifications, equivalents, and alternatives falling within the spirit and scope of the invention as defined by the appended claims.

In the following a double U-core Switched Reluctance Machine (SRM) is presented and the elements of the SRM is disclosed.

The following embodiments relates to a switched reluctance machine (SRM), utilising a topology, which has the advantages of shorter flux path, less magnetic coupling, short end windings, magnetic gearing, and the possibility of internal cooling. In extend to the specific topology, it also maintains the advantages of the conventional SRM, which is great efficiency at both low and high speeds and cheaper production, as no magnets are used.

FIG. 2 shows flux lines of an embodiment of a double U-core SRM.

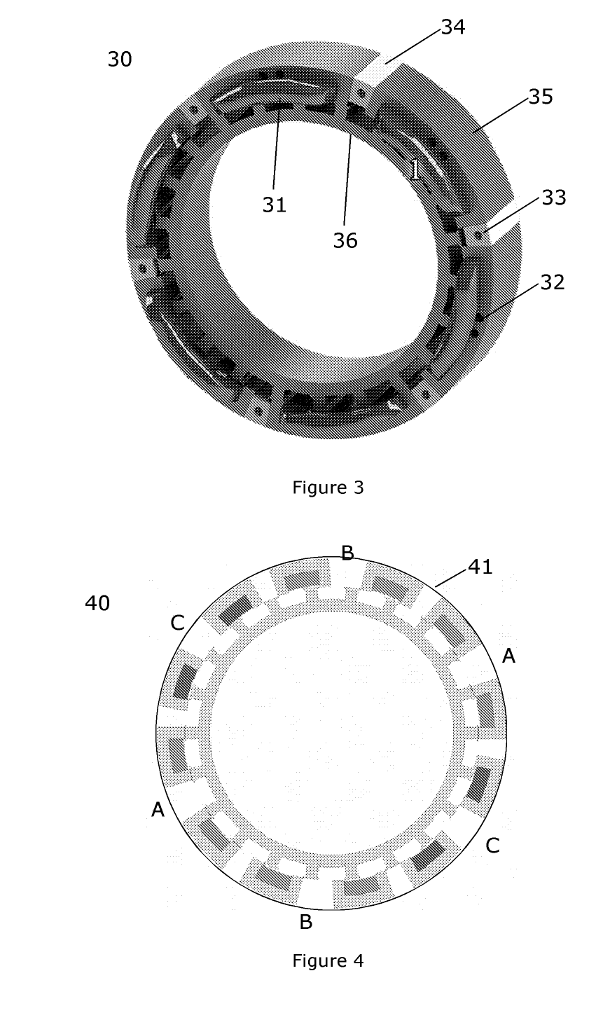

FIG. 3 shows the same machine 30 as in FIG. 2 where the details are:

1) Short end windings 31,

2) Internal cooling channels 32, 33,

3) Ceramic or other non-conducting material separation blocks/wedges 34,

4) Stator segments 35,

5) Rotor 36.

FIG. 4 shows an embodiment of the machine with three phases A, B, C and a compression ring 41, which can be attached the stator segments in a crimp process.

It has been shown that the end windings are the thermal limitation during high load situations. It is difficult to arrange the end windings in a compact manner which is the optimum with respect to the thermal conductivity, and high temperature differences have been observed between the windings in one end and the center of a SRM machine according to the prior art. Furthermore, the end windings only contributes with losses and they take up physical space, as the paths of the end windings from the 3 phases intersects.

The prior art U-core SRM has a stack length of 119 mm but to make room for the end windings the total length of the first version is 291 mm, excluding the encoder. Hence, the amount of end winding must be minimized to obtain a more compact design, in addition to the reduction of loss. Due to the full pitch windings of the prior art U-core SRM, illustrated by the dashed circle in FIG. 6, this entails that the rotor diameter is kept as small as possible. An advantage of the traditional SR machine is the compact end windings, which are compact in the axial direction, and closely packed against the stator laminations which improves the conduction of heat from the end windings. Another advantage of the windings of a traditional SRM is the possibility of pre-winding the coils on bobbins. This feature is not a possibility for the coils of the prior art U-core SRM.

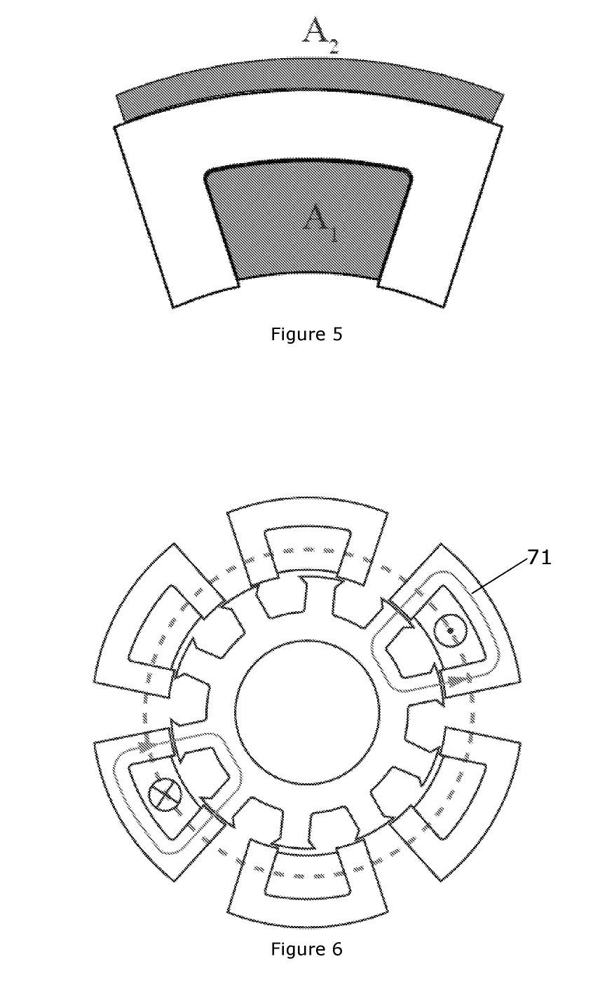

The prior art suggests that the U-cores should be wound around the yoke of the stator cores as illustrated in FIG. 5, where area A₁ equals A₂. This should reduce the length of the end windings and make them more compact, and coils of each phase are separated, hereby improving the cooling of the coils. However, the copper in A₂ increases the outer diameter of the stator and the copper present in A₂ does not add to the mmf produced, hence this winding scheme does not improve the efficiency of the SRM compared to the full pitch windings of a U-core SRM if the length to diameter ratio is large.

U.S. Pat. No. 7,312,549 suggests that E-cores form a transverse flux, which avoids the full pitch windings by placing two U-cores next to each other to form the E-core, hence keeping end windings short. However, while maintaining the short flux paths, this solution is only applicable for low speed applications, as the laminations of the E-cores are parallel with the shaft, hence posing a large surface which is penetrated by flux when current is applied to the coil in every other position than aligned. Furthermore, a magnetic gearing inherrent by the U-core technology is no longer present.

An improved embodiment to the prior art present above is found by arranging the stator segments which share a coil closer together, it is essential that each coil is separated from the others as seen in the conventional SRM. This may be obtained by having two separate coils for each phase, each coil spanning two U-cores placed next to each other as illustrated by the dotted line in FIG. 8 where only one phase of the SRM is shown.

For a switched reluctance machine it is preferred to have a ratio between stator and rotor poles be a non-integer. The higher the number of stator poles the higher the number of power converters has to be used in order to supply power to the machine.

In an embodiment a three phase 24/22 U-core SRM is obtained. The number of poles per phase has been doubled, but each coil is separated from the others, which enables a closer packing of the end windings, and the length of the end windings is reduced and not influenced by the stator diameter to the same extend as seen in the prior art U-core SRM. This is an important property, as the increased number of poles requires a larger stator diameter to obtain an inductance ratio corresponding to the U-core SRM of the prior art.

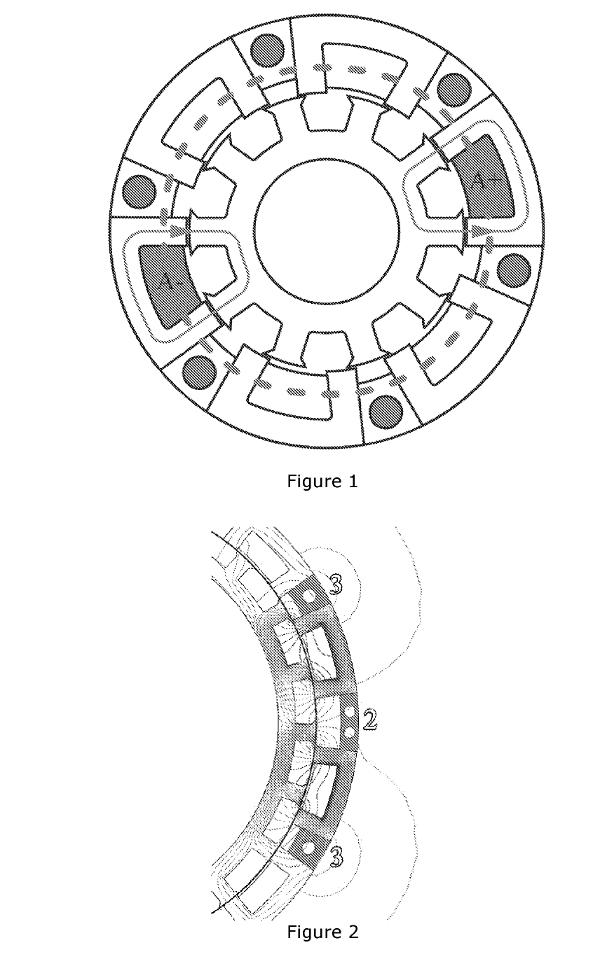

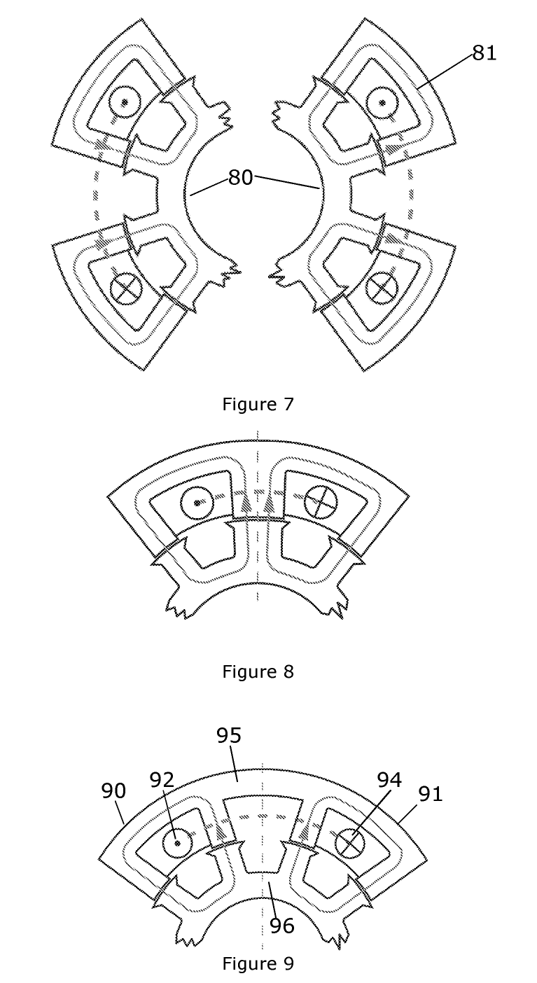

To evaluate the difference between an embodiment of the prior art, see FIG. 6, where FIG. 6 shows the same U-core layout as seen in FIG. 1 and the embodiment, see FIG. 7, the two embodiment are compared using the same amount of core material. As the number of stator segments are doubled in the double U-core SRM, the stack length must be halved. Hence, if the U-core containing the right hand side flux path 71 in FIG. 6 is split into two segments of half the length, the U-cores containing the right hand side flux path 81 in FIG. 7 are obtained. FIG. 7 only shows two stator segments 80.

The flux linkage in the two paths where the rotor is in aligned position are described by equation (1) where the reluctance of the laminations is neglected.

$$λ = Li = \frac{{N}^{2}}{ℜ} i = \frac{{μ}_{0} {A}_{air} {N}^{2}}{{l}_{air}} i \qquad ( 1 )$$

In order to keep the volume of core material constant, the length of the stack is halved. However, the number of stator poles is doubled, hence the same pole area Aₐᵢᵣ is obtained. Hereby the magnitude of the aligned inductance L is maintained, which yields equivalent flux linkage in the two embodiments if the current i and number of turns N as well as lₐᵢᵣ is kept constant. To obtain an unaligned inductance that resembles that of the prior art U-core SRM, intuitively, the air gap radius must be twice as large as for the prior art U-core SRM, as the distance between stator and rotor poles in unaligned position must be maintained. This entails a rotor diameter which is twice the size, however, as the stack length is halved, the amount of rotor material is kept approximately constant.

If the inductance ratio of the double U-core SRM resembles that of the prior art U-core SRM, it is seen from equation 2 that the torque is approximately doubled, as the number of rotor poles is changed from 10 to 22, hereby approximately halving ∂θ.

$$τ ( t ) = \frac{1}{2} \frac{\partial L ( θ )}{\partial θ} {i}^{2} \qquad ( 2 )$$

where τ is the torque, L is the inductance and θ is the angle of the rotor.

The embodiments of the invention is more complex compared to the prior art, as the number of stator segments to be retained by the stator housing is doubled. However, if they are placed close next to each other, it is seen, that they resemble an E-core, illustrated in FIG. 8.

FIG. 8 shows that the e flux in the middle leg of the E-core has the same direction and the magnetic circuit is symmetric around the dotted line, hence the two circuits have a minimal influence on each other. The use of an E-core like FIG. 8 will result in a asymmetric flux distribution in the poles, whereas the embodiment of FIG. 9 produces a more symmetric flux distribution, which in the end provides a higher torque from the machine.

FIG. 9 shows a stator segment with a first U-core 90 with a wire 92 and a second U-core 91 with another wire 94 pointing in opposite direction, the two U-cores are separated by a gap. By introducing a bridge 95, 96 which connects the two U-cores, and thereby fill the separation gap. As illustrated in FIG. 9 a double U-core is formed, and the number of stator segments has been reduced to six as in the prior art U-core SRM without severely compromising the magnetic circuits. The thickness of the bridge 95, 96 does have influence on the unaligned inductance, hence this must be properly considered during the design phase.

It should be noted, that the doubling of the torque due to the reduction in ∂θ may be obtained by doubling the number of U-cores to form a 24/20 SRM while increasing the diameter and reducing the stack length as seen in FIG. 9, showing an embodiment following the arguments described of the prior art. Hereby, two coils spanning ¼ of the stator is obtained, each connecting two U-cores. However, if the diameter is doubled and the coil area is kept constant, the amount of end winding is doubled. As the stack length is halved, the relationship between end winding and copper which contributes to the mmf becomes worse. Furthermore, the end windings of the different phases continues to cross.

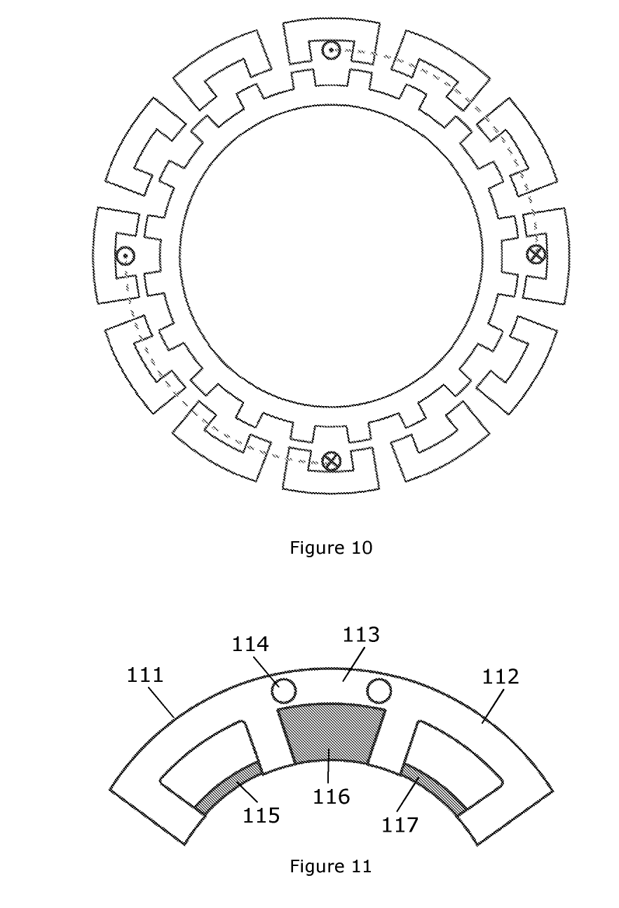

To summarise, the advantages of the double U-core compared to four separate U-cores as shown in FIG. 10 are that the amount of end winding is reduced and that the end windings of each phase are physically completely independent on each other, resulting in compact end windings which are easier to cool and which exhibits minimal mutual coupling. The result is a compact stator segment which may be pre-wound before assembly of the stator. Further more, the number of stator segments is halved when utilising double U-cores compared to using four separate U-cores.

Besides the thermal limitation posed by the end windings, prior art has shown, that the core loss comprises the main part of the total loss of the prior art U-core SRM. The core loss is divided into loss in the laminations and loss in the surroundings, where it has been shown, that the loss in the surroundings comprise 66% of the total core loss, including AC copper loss. Especially separation blocks, which can be formed as wedges between the stator laminations, are believed to lead to the main part of these losses, as they are directly penetrated by flux during operation.

As the wedges often are not laminated, the induction of eddy currents is only prevented by the low permeability and high electrical resistance of the austenitic stainless steel. As the wedges are introduced to retain the stator segments, they are essential to the U-core topology and cannot be left out. Hence alternative materials are exploited as substitute to the austenitic stainless steel. The requirements to this material are:
High stiffness
Electrically non-conducting
Low permeability
Should maintain its properties at elevated temperatures
High thermal conductivity
Coefficient of thermal expansion similar to laminations

Furthermore, the material must be economically feasible and demonstrate properties which enables production. These properties are considered during the exploration of a replacements for the stainless steel.

Ceramic spacers between the salient stator poles near the air gap in a regular SRM can been utilised to improve the acoustic properties with respect to noise by increasing the stiffness of the stator. As the ceramic material is a dielectric and non-magnetic material, no eddy currents will be induced, hence no additional losses are added by the spacers. Furthermore, as the E-module is 370 GPa, it surpasses steel in stiffness, and the material has good thermal stability. A disadvantage of the ceramic material is the costs relating to the production of the wedges, as tight tolerances are required.

An alternative to ceramic materials is concrete. Concrete has been used as filler material in the rotor of a SRM for pump applications by casting the concrete directly in the rotor. Concrete is cheap and by casting the wedges directly in the stator it is possible to obtain the appropriate tolerances. Furthermore, by casting directly, the thermal contact resistance between laminations and wedges is minimised. To maintain the internal cooling which is featured in the prior art U-core SRM, cooling tubes must be implemented in the wedges. However, as the goal of using concrete as wedges is to remove the magnetic and electrically conducting material between the stator segments, the choice of material for the cooling pipes is limited to a polymer or direct casting of cooling channels in the concrete wedge. In a previous section it was discussed, that the Teflon tube utilised in the prior art U-core SRM represents a large thermal resistance which is a general tendency for ordinary polymers, although exceptions exists, hence the choice of polymers is not suitable. The direct casting of cooling channels present the path with the lowest thermal resistance between the heat source and coolant. However, the concrete is subject to swelling under moist conditions, and the connection to the integrated cooling channels is more difficult compared to a solid tube used as guide for the coolant. The solid tube presents a more robust way of introducing cooling.

To maintain the integrated cooling, the bridge is utilised, see FIG. 11. As the amount of flux running in the bridge is limited, the choice of material for the cooling pipe 114 is less restricted, as no eddy currents are induced in the cooling pipe, even if it is made from a conducting material. Hereby the internal cooling of the U-core SRM is maintained and it is possible to place the coolant close to the coils. In addition to the implementation of the cooling pipes, the bridge provides a mean of clamping the Double U-cores together axially using internal threaded rods instead of using the external threaded rods as it is seen on the prior art U-core SRM. Hereby, the acoustic performance is improved, as the external threaded rods on the prior art U-core SRM vibrated under operation. The axial clamping may be performed by using the cooling pipes or with a separate stay bolt. As long as the solution is implemented in the bridge, additional losses due to eddy currents can be minimised.

FIG. 13 shows three adjacent stator segments 131, 132, 133 with separation blocks 134, 135 between the adjacent segments, these separation blocks 134, 135 are optional.

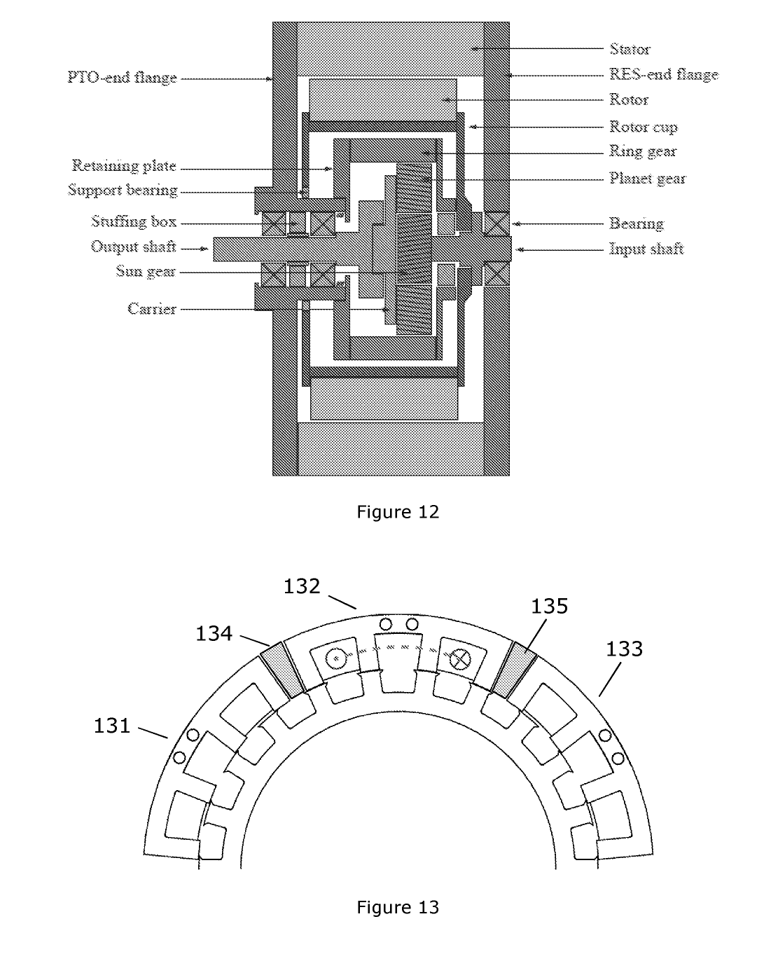

In an embodiment the structural support of the double U-core SRM is enabled by using flanges (see FIG. 12) attached to the ends of the stator segments 131, 132, 133.

The separation blocks, 134, 135 are formed to fit the gap between two segments 131, 132, 133. The separation block may also comprise cooling channels in axial direction, whereby the leg of the U-core facing the separation block is cooled.

The coolant may be any suitable cooling fluid, liquid or gas.

The mass of the prior art U-core SRM is 17.8 kg. As the prior art U-core SRM has served as a proof of concept, the mass has not been a concern during development. However, for the second prototype, the mass has to be reduced as the U-core SRM must approach a technology which has the potential to compete with PM and induction machines in the automotive industry. This entails developing a mechanical construction which utilises all materials to their full potential, preferably fulfilling more than one purpose. In the prior art U-core SRM, the stator segments are retained by a stiff stator housing. This housing has a mass of 4.2 kg which is 23.6% of the total weight, hence this is seen as an area where improvements must be made. The alternative to relying on an extra component to contribute with the structural rigidity of the stator, is to use the stator segments as the main structural elements. As the stator is constituted of several separate components it is only able to support compression. Hence, if a ring is crimped around the stator, everything is fixed. To further improve the mechanical stiffness of the stator and enhance the acoustic performance, spacers are inserted between stator poles, see FIG. 12 where the spacers are indicated as the gray areas 115, 116, 117.

It is known that the assembly process with the spacers can be difficult, where the spacers are cooled by a ΔT of −200° C. and the stator laminations are heated by a ΔT of 100° C. to obtain a pre-tension in the final assembly.

These issues may be avoided by casting the spacers in concrete and subsequently compress the whole assembly with the aforementioned crimp ring. The spacers in the coil area 115, 116 will reduce the area available for the coil, however, this is not a problem, as the coil is retracted from the air gap to avoid current displacement and hot spots. Besides increasing the stiffness of the stator by implementing the spacers, the possibility of making a pancake type machine with a small length to diameter ratio which further improves the stiffness, as the end flanges adds stiffness to the short stack. This is expected to increase the acoustic performance as well.

The ring which is crimped onto the stator to place the stator segments and wedges under compression is designed to allow an outer cooling jacket for evaluation purposes. The outer cooling jacket is added to ensure good thermal conditions for the double U-core SRM under test in the entire area of operation.

As the rotor diameter is increased in the double U-core SRM, empty space is present inside the rotor. To utilise this space, a planetary gearbox could be installed, hereby making the Double U-core SRM a compact unit with the correct speed on the output shaft. The gear can be implemented as illustrated in FIG. 12.

In another embodiment the space in the rotor can used to implement other mechanical equipment, such as a pump.

In another embodiment the space in the rotor can used to implement electrical equipment, such as power electronic inverters for controlling the double U-core SRM.

The rotor laminations are installed on the rotor cup, which is mounted on the input shaft of the planetary gear which is connected to the sun gear, The rotor cup is furthermore supported in the left side by a support bearing. The carrier of the planet gears is connected to the output shaft, and the ring gear is fixed to the PTO-end flange of the SRM through a retaining plate. The output shaft is supported by two bearings and runs through a stuffing box to seal the gear oil inside the planetary gearbox. The input shaft is supported in one end by the bearing in the RES-end flange which is sufficiently, as the other end is supported through the rotor cup by the support bearing.

By introducing the initiatives just described, several problems in the prior art U-core SRM is solved. The torque of the double U-core SRM has been doubled compared to the prior art U-core SRM using the same amount of magnetic material, and the amount of end winding has been reduced considerably, improving the thermal properties and reducing the amount of space necessary to contain the copper. At the same time, the material of the stator segments fulfils several purposes, as they are utilised to provide structural rigidity which renders the thick stator housing redundant, as well as they enable the implementation of internal cooling 114 in a region where ideally no flux exists, which makes the demands to the cooling pipe material less strict.

The stator laminations furthermore provides means for internal axial clamping, hence the external threaded rods seen on the prior art U-cores SRM is avoided, contributing to a better acoustic performance. The acoustic performance is furthermore improved by the introduction of the spacers, and the fact, that it is possible to obtain a pancake-like form factor enables for the end flanges to provide stiffness to the short stator.

The filling material the spacer can be made of: a ceramic based material, polymer material or cement based material or like.

The larger diameter leads to empty space inside the rotor. In an embodiment this space can be used to implement the planetary gear as described.

As described, the double U-core topology offers significant advantages compared to the single U-core used in the prior art U-core SRM. However, the advantages is obtained at the expense of a higher commutation frequency and larger rotor diameter, which entails larger windage losses. With regard to the mechanical construction, several new concepts are introduced which increases the mechanical complexity of the SRM, especially during the assembly process. Furthermore, as the diameter of double U-core SRM is larger than for prior art U-core SRM, an air gap of 0.3 mm might not be maintained, hence part of the torque gained by the larger rotor diameter is lost due to the larger air gap.

The increased commutation frequency entails larger core loss as well as larger switching losses in the inverter when the double U-core SRM operates in single pulse mode. Hence the optimisation of the magnetic circuits may be a balance between the speed and weight of the SRM.

In order to assess whether the embodiments of the double U-core SRM has the advantages as discussed, an initial analysis is performed. The double U-core SRM is scaled, so that the total volume of core material as well as the coil area is the same as the prior art U-core SRM. It is then considered, how the inductances compare, in relation to the previous considerations. Furthermore, the generated torque with the same applied current density is considered. The double U-core SRM used for the analysis is illustrated in FIG. 13.

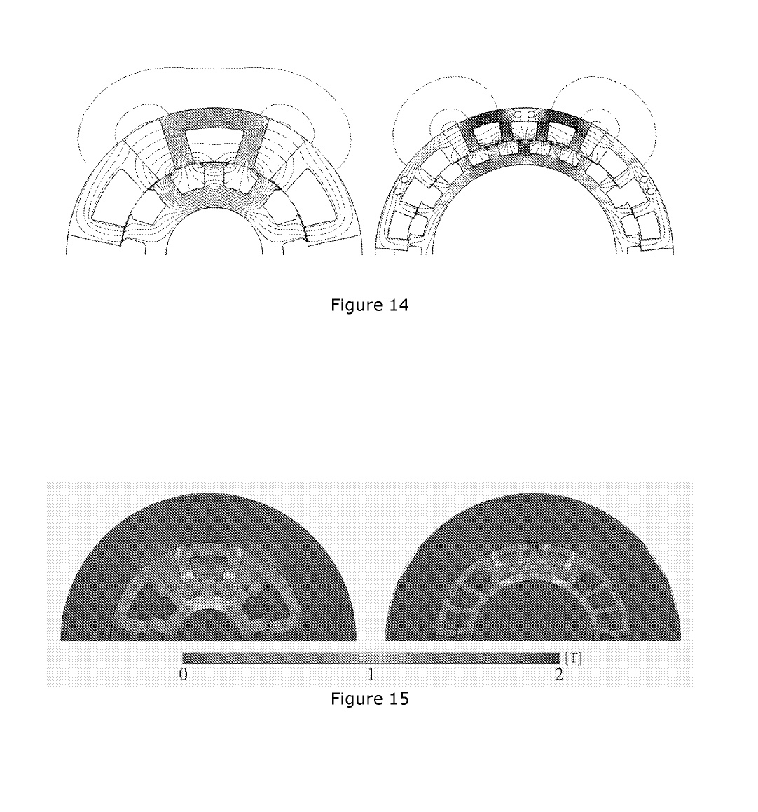

In FIG. 14, the flux paths of the new and old SRMs are seen and in FIG. 15, the flux density at 15 A/mm̂2 is seen. As the double U-core SRM features two magnetic circuits containing the same amount of flux as the single circuit excited in the prior art U-core SRM, 50 flux lines are used for the double U-core SRM while only 25 lines are used for the prior art U-core SRM. The figures are seen for the unaligned positions at 15 A/mm², where leakage flux is most distinct. Considering the two topologies in terms of the flux paths and leakage flux, there are only minor differences. In both topologies, there are a considerable amount of flux going through the neighbouring stator segments. This was found to result in eddy current losses in the wedges between the prior art U-core SRM.

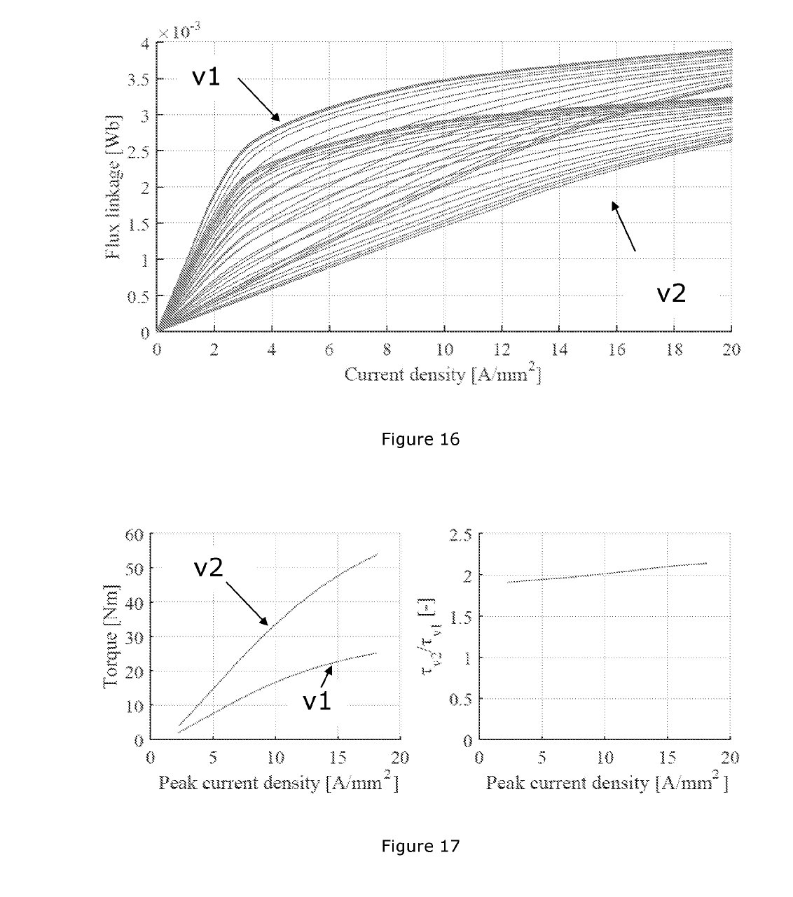

Using the two magnetostatic models, magnetisation curves are created for both versions. These are illustrated in FIG. 16. Both unaligned and aligned inductances are slightly lower for the double U-core SRM, it is better with a lower inductance in the machine. It is assessed that the area of the two curves W are the same. The areas, which is the energy supplied in each stroke by each phase, is used to estimate the lossless average torque at different current densities, as given by

$$τ = \frac{{mn}_{r}}{2 π} W .$$

The torque as well as the factor between the torque of the prior art U-cores SRM and the double U-core SRM is illustrated in FIG. 17. As expected, the torque is twice as large utilising the double U-core SRM, and even increases slightly at higher current densities. It is therefore assessed that the new topology has the expected advantages regarding increased torque.

Although several embodiments presented shows a rotating machine with a circular stator. The invention is not limited to a circular stator and a circular machine. In an embodiment the electrical machine stator is arranged with a plurality of stator segments aligned in a linear setup.

It will be understood that the benefits and advantages described above may relate to one embodiment or may relate to several embodiments. It will further be understood that reference to ‘an’ item refer to one or more of those items.

It will be understood that the above description of a preferred embodiment is given by way of example only and that various modifications may be made by those skilled in the art. The above specification, examples and data provide a complete description of the structure and use of exemplary embodiments of the invention.

1. An electrical machine stator comprising a plurality of stator segments, each segment comprises a first U-core and a second U-core wound with a winding,
said winding being arranged with at least one coil turn, each coil turn comprises a first axial coil segment and a second axial coil segment and one or more end segments, wherein the first and second axial coil segments are arranged in opposite directions to each other,
the first U-core receives the first axial coil segment(s) and the second U-core receives the second axial coil segment(s), wherein the first U-core and the second U-core are located adjacent to each other, whereby the winding spans the first and second U-cores.

2. The electrical machine stator according to claim 1, wherein:
the plurality of stator segments are arranged in a circular manner, adjacent to each other with a separation block between the adjacent segments, wherein the separation blocks being of an electrically and magnetically non-conducting material.

3. The electrical machine stator according to claim 1, wherein the winding of each of the plurality of stator segments alternates in a sequence of a plurality of electrical phases, such as three electrical phases.

4. The electrical machine stator according to claim 1, comprising a separation gap between the first U-core and the second U-core.

5. The electrical machine stator according to claim 4, wherein the separation gap comprises at least one bridge connecting the first U-core and the second U-core.

6. The electrical machine stator according to claim 5, wherein the bridge comprises at least one hole in axial direction, said hole can be used for axial clamping and/or as a cooling channel.

7. The electrical machine stator according to claim 1, further comprising a circular ring around the plurality of stator segments, said circular ring provides a firm structural support to the plurality of stator segments.

8. The electrical machine stator according to claim 7, whereby the circular ring is crimped around the plurality of stator segments as a pre-stressed outer compression ring.

9. The electrical machine stator according to claim 4, further comprising a plurality of spacer fillings, where the empty spaces may be filled with preferable non-magnetic and/or non-conducting filling material.

10. The electrical machine stator according to claim 9, wherein the filling material is a ceramic based material, polymer material or cement based material.

11. (canceled)

12. (canceled)

13. The electrical machine stator according to claim 2, wherein the winding of each of the plurality of stator segments alternates in a sequence of a plurality of electrical phases, such as three electrical phases.

14. The electrical machine stator according to claim 2, comprising a separation gap between the first U-core and the second U-core.

15. The electrical machine stator according to claim 3, comprising a separation gap between the first U-core and the second U-core.

16. The electrical machine stator according to claim 13, comprising a separation gap between the first U-core and the second U-core.

17. The electrical machine stator according to claim 14, wherein the separation gap comprises at least one bridge connecting the first U-core and the second U-core.

18. The electrical machine stator according to claim 15, wherein the separation gap comprises at least one bridge connecting the first U-core and the second U-core.

19. The electrical machine stator according to claim 16, wherein the separation gap comprises at least one bridge connecting the first U-core and the second U-core.

20. The electrical machine stator according to claim 2, further comprising a circular ring around the plurality of stator segments, said circular ring provides a firm structural support to the plurality of stator segments.

21. An electrical machine comprising a rotor and a stator, wherein the stator is according to claim 1.

22. The electrical machine according to claim 21, wherein a gear is included inside the rotor.
